(19) United States
(12) Patent Application Publication
(10) Pub. No.: US 2014/0335487 A1
(43) Pub. Date: Nov. 13, 2014

(54) SYSTEMS AND METHODS FOR RESPONSE INHIBITION SWITCHING TASK INCORPORATING MOTION FOR ENHANCING COGNITIONS

(71) Applicant: LUMOS LABS, INC., San Francisco, CA (US)

(72) Inventors: Tyler HINMAN, San Francisco, CA (US); Aaron KALUSZKA, Hayward, CA (US); Benjamin Lee AHRONI, San Francisco, CA (US)

(73) Assignee: LUMOS LABS, INC., San Francisco, CA (US)

(21) Appl. No.: 14/273,180

(22) Filed: May 8, 2014

Related U.S. Application Data
(60) Provisional application No. 61/822,511, filed on May 13, 2013.

(51) Int. Cl. G09B 19/00; G06F 3/0484; G06F 3/0481

(52) U.S. Cl. CPC G09B 19/00; G06F 3/0481; G06F 3/04842
USPC 434/236

(57) ABSTRACT

A method and apparatus for training attention ability aspects of cognitive ability of a user is disclosed which may comprise conducting, via a user computing device user interface display, a trial which may comprise: presenting, via the user computing device user interface display, a plurality of objects comprising a visually recognizable pointing direction pointing in an axis with respect to the user interface display and moving in an axis with respect to the user interface display; presenting, via a user computing device, the objects in one of a corresponding mode wherein the pointing direction of each object corresponds to the movement direction of each object and a non-corresponding mode wherein the pointing direction is different from the movement direction; requiring the user to input a response indicating one of the pointing direction and the movement direction.

### RELATED CASES

This application claims priority to U.S. Provisional Patent Application No. 61/822,511, entitled, SYSTEMS AND METHODS FOR RESPONSE INHIBITION SWITCHING TASK INCORPORATING MOTION FOR ENHANCING COGNITIONS, filed on May 13, 2013, the disclosure of which is incorporated in the present application for all purposes as if the Provisional Application, including the entire specification, claims and drawing were repeated here fully and completely.

### BACKGROUND

Response inhibition or inhibitory control refers to the ability to prevent actions in inappropriate contexts. Task switching or cognitive flexibility refers to the ability to switch between different tasks or rules. These abilities are important components of attention, the ability to selectively concentrate on one aspect of the environment while ignoring others, and executive functioning, the higher-order cognitive ability encompassing the ability to control one's thinking Enhancing these capacities is highly desirable.

Researchers have long used interference and task switching paradigms to measure executive functions. See, Stroop, J. R. (1935). “Studies of interference in serial verbal reactions”. Journal of Experimental Psychology 18 (6): 643-662; and Rogers R. D. and Monsell S. (1995). “The cost of a predictable switch between simple cognitive tasks”. Journal of Experimental Psychology: General, 124, 207-231. They have been further employed to improve those functions, as well as showing benefits extending to measures of fluid intelligence. See, Karbach, J. and Kray, J. (2009), How useful is executive control training'? Age differences in near and far transfer of task-switching training Developmental Science, 12: 978-990. Further, there have been a number of attempts to develop programs to enhance attentional abilities. For example, Attention Process Training, which incorporates interference tasks, has shown success at reducing the burden of attention deficit hyperactivity disorder (ADHD) in children and traumatic brain injury (TBI), but also applies to general populations. See, Sohlberg, M. M. and Mateer, C. A. (1987). “Effectiveness of an attention-training program”. J Clin Exp Neuropsychol 9 (2): 117-30. These promising approaches demonstrate the appeal of task switching and response inhibition training; however, they are not without their limitations. In particular, none have included motion as a parameter. The inclusion of motion is important for increasing ecological validity and more domain-general improvements of executive function, as many daily activities such as driving require attention to moving objects. Further, including more natural, active stimuli increase understanding and engagement in the task.

### SUMMARY

In this specification, methods and systems for cognitive training exercises that train response inhibition and task switching abilities in an intuitive, engaging, and adaptively challenging way to enhance cognition are disclosed. These exercises engage users in a task where they are presented with a set of one or more objects, all of which are pointing in the same direction and moving as a group, but possibly pointing in a different direction than they are moving. Users are prompted, for example, to determine in which direction the object(s) are either pointing or moving, and the prompt can change.

An aspect of the disclosure is directed to a method of training attention ability aspects of cognitive ability of a user. The methods comprise: conducting, via a user computing device user interface display, a trial comprising: presenting, via the user computing device user interface display, a plurality of objects with a recognizable pointing direction and a recognizable moving direction; presenting, via a user computing device, the objects in one of a corresponding mode wherein the pointing direction of each object corresponds to the movement direction of each object and a non-corresponding mode wherein the pointing direction is different from the movement direction; requiring the user to input a response indicating one of the pointing direction and the movement direction. Additionally, the methods can include: determining, via the user computing device, whether the response is correct or incorrect. In other aspects, the method can further comprise: after a response determined to be correct, increasing, via the user computing device, a progress amount within a difficulty level for the user; determining, via the user computing device, whether the progress amount has reached a progress amount threshold; increasing a difficulty level if the progress amount threshold is reached or exceeded. In still other aspects, the methods can comprise: after a response is determined to be incorrect, determining, via the user computing device, if a decrease has occurred in the progress amount by the user at the current training difficulty level; and if it is determined that there has not been a decrease in progress amount, decrementing, via the user computing device, the training difficulty level for the user. In some aspects the directions comprise one of the four directions indicated by the direction input keys on a physical or virtual keyboard user interface; and the user input is made using the physical or virtual keyboard user interface. In other aspects, after determining a response to be incorrect, determining if an increase has occurred in the progress amount by the user at the current training difficulty level; and if it is determined that there has not been an increase in progress amount, decrementing the training difficulty level for the user.

Another aspect of the disclosure is directed to an apparatus for training attention ability aspects of cognitive ability of a user. The apparatus comprises, a user computing device configured to present to a user a trial comprising: presenting on a display of the user computing device, a plurality of objects with a recognizable pointing direction and a recognizable moving direction; presenting the objects in one of a corresponding mode wherein the pointing direction of each object corresponds to the movement direction of each object and a non-corresponding mode wherein the pointing direction is different from the movement direction; and requiring the user to input a response indicating one of the pointing direction and the movement direction. Additionally, the user computing device can be configured to: determine whether the response is correct or incorrect; whether after a response determined to be correct, increase a progress amount within a difficulty level for the user; determine whether the progress amount has reached a progress amount threshold; and/or increase a difficulty level if the progress amount threshold is reached or exceeded. In some configurations, the device can be configured such that after determining a response is incorrect, determine if a decrease has occurred in the progress amount by the user at the current training difficulty level; and after determining there has not been a decrease in progress amount, decrement the training difficulty level for the user. In still other configurations, the directions comprise one of the four directions indicated by the direction input keys on a physical or virtual keyboard user interface; and the user input is made using the physical or virtual keyboard user interface.

Yet another aspect of the disclosure is directed to a tangible machine readable medium storing instructions that, when executed by a computing device, cause the computing device to execute a method of training a spatial visualization aspect of the cognitive ability of a user, the method comprising, conducting a trial comprising: presenting on a user computing device user interface display a plurality of objects comprising a visually recognizable pointing direction pointing in an axis with respect to the user interface display and moving in an axis with respect to the user interface display; presenting the objects in one of a corresponding mode wherein the pointing direction of each object corresponds to the movement direction of each object and a non-corresponding mode wherein the pointing direction is different from the movement direction; and requiring the user to input a response indicating one of the pointing direction and the movement direction. Additionally, the method further comprising: determining, via the user computing device, whether the response is correct or incorrect. Then after determining a response to be correct, increasing, via the user computing device, a progress amount within a difficulty level for the user; and determining whether the progress amount has reached a progress amount threshold. In some configurations, the method further comprising: increasing a training difficulty level if the progress amount threshold is reached or exceeded. Then after determining a response to be incorrect, determining if an increase has occurred in the progress amount by the user at the current training difficulty level; and if it is determined that there has been an increase in the progress amount, incrementing the progress amount for the user.

### INCORPORATION BY REFERENCE

All publications, patents, and patent applications mentioned in this specification are herein incorporated by reference to the same extent as if each individual publication, patent, or patent application was specifically and individually indicated to be incorporated by reference, for all purposes and as if the document were repeated verbatim in the present application including all of the specification text, claims and figures.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosed subject matter and its operation are utilized, and the accompanying drawings of which:

FIG. 1 is a screenshot that illustrates an exemplar trial requiring the user to respond to pointing direction according to aspects of the disclosed subject matter;

FIG. 2 is a screenshot that illustrates a trial requiring the user to respond to moving direction according to aspects of the disclosed subject matter;

FIG. 3 is a screenshot of a title screen according to aspects of the disclosed subject matter;

FIG. 4 is a flow diagram illustrating an example of a tutorial flow according to aspects of the disclosed subject matter;

FIG. 5 is a screenshot that indicates instructions for input methods according to aspects of the disclosed subject matter;

FIG. 6 is a screenshot of instructions for pointing stimuli according to aspects of the disclosed subject matter;

FIG. 7 is a screenshot of instructions for moving stimuli according to aspects of the disclosed subject matter;

FIG. 8 is a screenshot of strategy tips at the end of a tutorial according to aspects of the disclosed subject matter;

FIG. 9 is a flow diagram directing users to play the tutorial according to aspects of the disclosed subject matter;

FIG. 10 is a screenshot of a tutorial prompt according to aspects of the disclosed subject matter;

FIG. 11 is a flow diagram illustrating game flow according to aspects of the disclosed subject matter;

FIG. 12 is a screenshot illustrating a correct indicator according to aspects of the disclosed subject matter;

FIG. 13 is a screenshot illustrating an incorrect indicator according to aspects of the disclosed subject matter;

FIG. 14 is a flow diagram illustrating a trial flow and the determination of progress according to aspects of the disclosed subject matter;

FIG. 15 is a screenshot of a heads-up display featuring time remaining, score, progress meter and score multiplier according to aspects of the disclosed subject matter; and

FIG. 16 is a screenshot of a summary screen which lists score and session statistics according to aspects of the disclosed subject matter.

### DETAILED DESCRIPTION

### I. Computing Systems

The systems and methods described herein rely on a variety of computer systems, networks and/or digital devices for operation. In order to fully appreciate how the system operates, an understanding of suitable computing devices and systems is useful. The computing devices, systems and methods disclosed herein are enabled as a result of application via a suitable computing device (including without limitation mobile devices such as mobile phones and tablets).

In at least some configurations, a user executes a browser to view digital content items and can connect to the front end server via a network, which is typically the Internet, but can also be any network, including but not limited to a mobile, wired or wireless network, a private network, or a virtual or ad hoc private network. As will be understood very large numbers (e.g., millions) of users are supported and can be in communication with the website at any time. The user may utilize a variety of different computing devices. Examples of user devices include, but are not limited to, personal computers, digital assistants, personal digital assistants, cellular phones, mobile phones, smart phones, tablets or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application capable of or adaptable to allowing access to web pages on the World Wide Web. The browser can also include Flash™ from Adobe Systems, Inc.).

In at least some configurations, a user may download an App, e.g., onto the user's portable communication device, and play the cognitive training spatial visualization game on the user's hand held device or other user computing device.

### II. Software Programs Implementable in the Computing and Network Environments to Achieve a Desired Technical Effect or Transformation

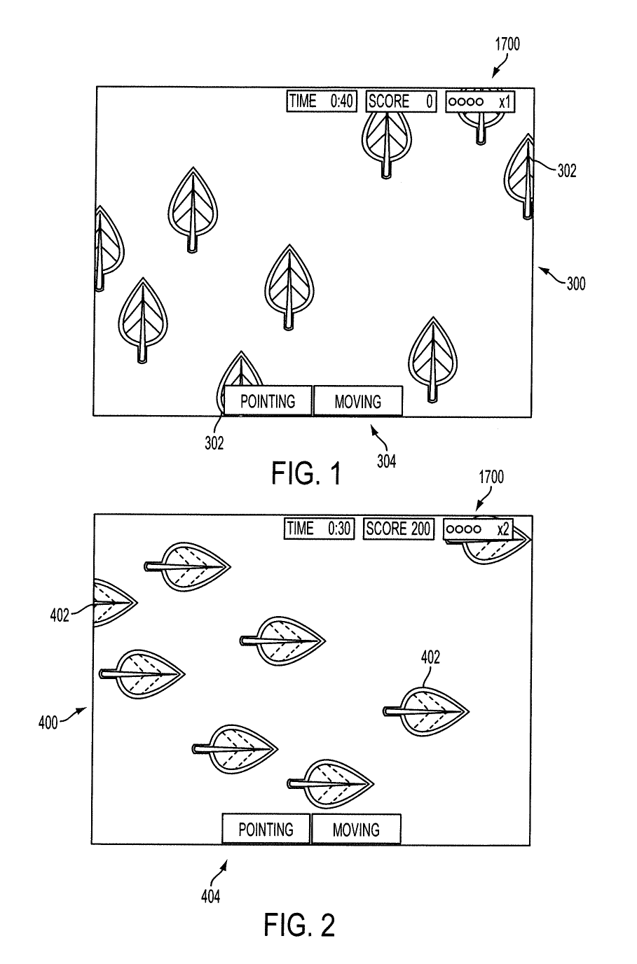

A goal of an exercise is to quickly and repeatedly specify the cardinal direction in which a set of objects is pointing or moving, two attributes that can interfere with each other, e.g., in influencing the reaction of the user. The core gameplay mechanism is the determination of pointing direction or moving direction of a set of one or more moving objects, which, can be, e.g., leaves 302 in FIG. 1 or 402 in FIG. 2. The objects 302, 402 could be arrows or any other items possessing directional attributes. In each trial, a user is directed to respond to pointing direction, e.g., as illustrated by way of example in the trial type bar 304, e.g., in FIGS. 1) and 404, e.g., in FIG. 2, or moving direction, e.g., as illustrated by way of example in FIG. 2. The trial type could be indicated in other ways, e.g., based on a cue such as the color of the object(s) and/or a textual indicator 304 in FIG. 1 or 404 in FIG. 2. Other cues also could be used to indicate to the user whether to respond to the pointing direction or moving direction. Alternatively, rather than a cue of the current target attribute, a switching cue could be presented, which can, e.g., provide a cue to the user only when the target attribute, e.g., pointing or moving, changes. Upon being shown the moving set of objects, the user can, e.g., indicate a direction through keyboard button presses, clicking or touching an on-screen direction indicator, or by gesturing in the desired direction on a touch screen or to another form of 3D input device (e.g. a Microsoft® Kinect® or a Wii wand).

After the user provides a response, that trial ends. The exercise quickly transitions to the next trial by, for example, flipping all objects on the screen to reveal the next set of moving objects and cue(s) or any other transition, a new color and/or direction of motion or direction of pointing of the on-screen objects, that indicates to the user that the next trial is beginning.

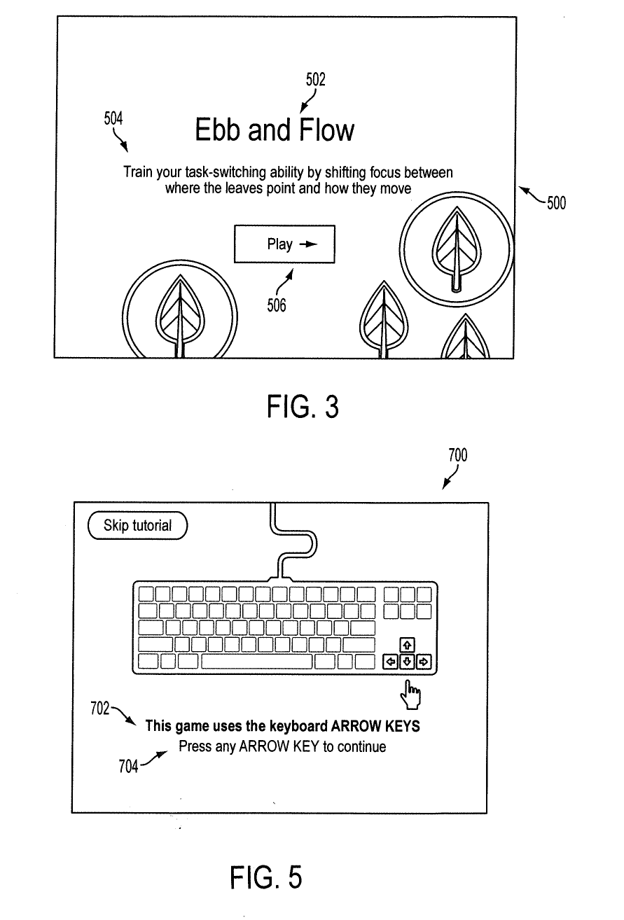

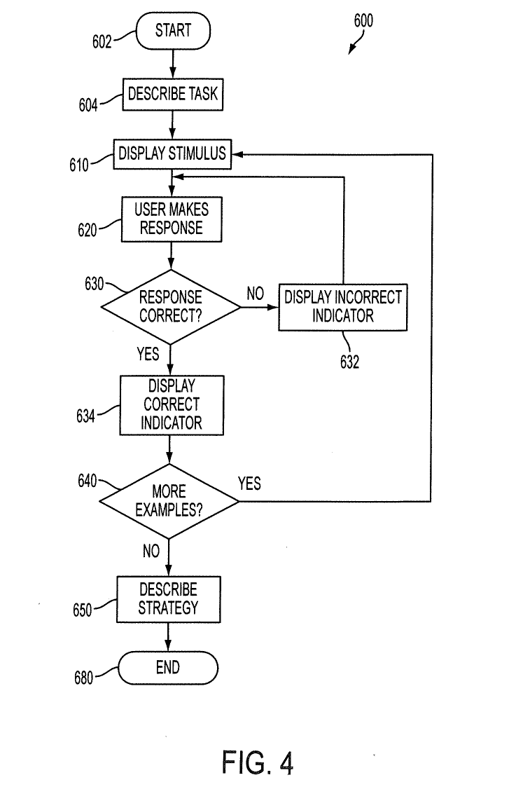

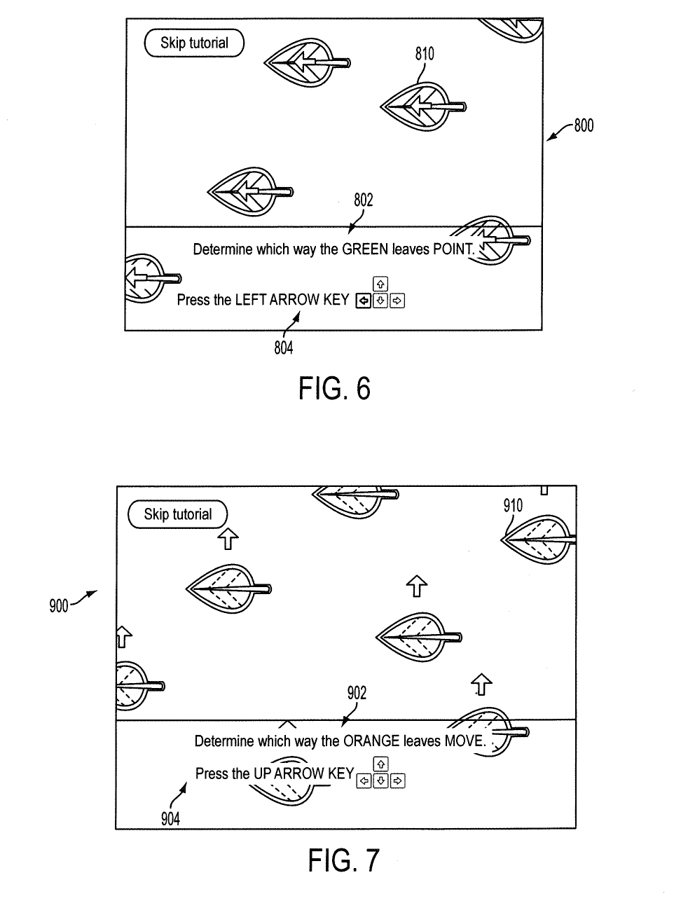

A user may be introduced to the training exercise via the title screen 500 (see, FIG. 3) and a short interactive tutorial describing the gameplay elements (see, FIG. 4), or by other methods to explain the rules of the training exercise. The title screen 500 may show a title 502, e.g., “Ebb and Flow,” and give a short summary 504 of the objective, e.g., “Train your task-switching ability by shifting focus between where the leaves point and how they move.” Also a “play” button 506 may be included. The tutorial flow diagram 600 of FIG. 4 begins after start block 602, by describing a task in block 604 and then displaying a stimulus in block 610, e.g., the leaves of a certain color moving in a certain direction. Thereafter a user makes a response in block 620, which is also recorded by the computing device, i.e., as explained in the directions 702 as part of the screen display 700 shown in FIG. 5, i.e., “This game uses the keyboard ARROW KEYS. Press any ARROW KEY to continue.” The response may also be made by the user in block 620, as illustrated by way of example in the screen displays 800 and 900 of FIGS. 6 and 7. As an example, the response may be as indicated by the directions 802, shown in FIG. 6, i.e., “Determine which way the GREEN leaves POINT,” and directions 804 “Press the LEFT ARROW KEY,” as the GREEN leaves 810 point to the left. In FIG. 7, the directions 902 on the screen display 900 may include, e.g., “Determine which way the ORANGE leaves MOVE,” and “Press the UP ARROW KEY” for ORANGE leaves 910 that are shown to be moving in the up direction on the screen display 900.

Returning to FIG. 4, if the response is not correct, as indicated in decision block 630, an incorrect indicator is display (and/or an audible prompt is provided), may be displayed in block 632. Thereafter the user may be prompted to make another response. If the response is correct, as determined in decision block 630, a correct indicator may be displayed in block 634 (and/or an audible prompt may be provided). Thereafter, more examples can be provided by providing another stimulus, as decided in decision block 640, e.g., as may be indicated by the number of prior trials, the apparent ability of the user to properly perform the task, etc. This process can be repeated as many times as desired. At the end of the tutorial, when no more examples are desired, a description of the strategy may be provided in block 670 and the tutorial can end in block 680.

The tutorial prompts the user to complete a series of simple game configurations with guided messages and prompts as seen, e.g., in the screen display 700 of FIG. 5). For example, the instruction 702 “This game uses the keyboard ARROW KEYS, and the instructions 704 “Press any ARROW KEY to continue,” could be suitable instructions where the user is using a computer keyboard to interface with the game. Other instructions, adapted to account for the interface employed by the user could also be provided. Other examples could include arrows on a touch screen, the numerical entry keyboard on a physical or virtual user interface keyboard, the physical or virtual phone keys on a smart phone or the like.

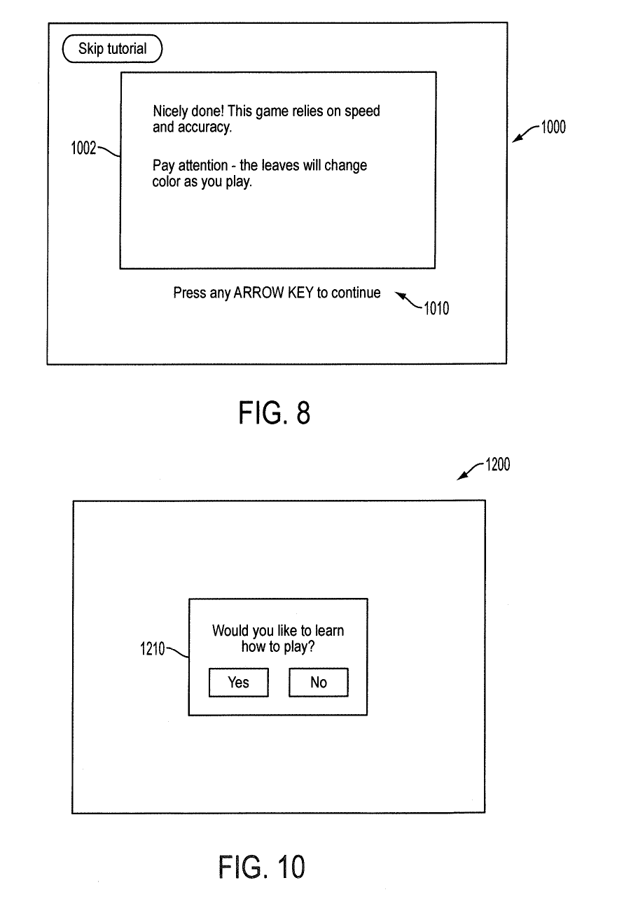

Important gameplay features such as responding to pointing direction, as illustrated by way of example on the screen display 800 of FIG. 6, comprising, e.g., instruction 802 “Determine which way the GREEN leaves point” and a moving direction, e.g., as illustrated in screen display 900 of FIG. 7, comprising the instruction 902 “Determine which way the ORANGE leaves move”), as noted above, can be displayed with animations. Interactive feedback can be utilized, as also noted above, to inform users of their success in understanding the task, and users may be given the chance to retry after making an error. After a number of successful trials, the user may be invited to start the game, e.g., utilizing the screen display 1000, as seen by way of example in FIG. 8, e.g., having a declaration 1002, such as, “Nicely Done! This game relies on speed and accuracy. Pay attention—the leaves will change color as you play.”). The user may also be directed by direction 1010 to “Press any ARROW KEY to continue.”

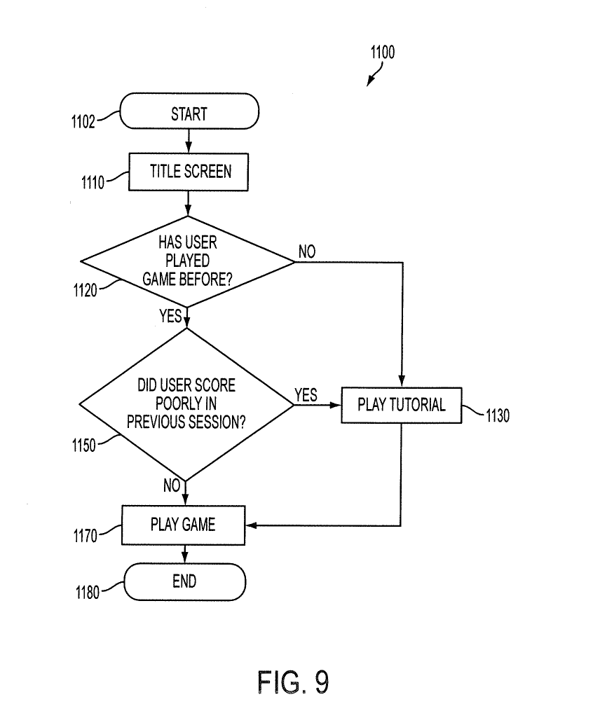

The tutorial may be recalled in the future if the user needs to be reminded how to play and dismissed if not needed, as indicated by the computing device process flow diagram 1100 of FIG. 9. The flow diagram 1100 of FIG. 9 may begin after start block 1102 by showing the title screen, in block 1110, e.g., as illustrated in FIG. 3, and thereafter the user may be asked whether the user has played the game before. If the user has not played the game, as determined in decision block 1120, e.g., from input from the user, e.g., in response to a screen display of such a question to the user. The user can play the tutorial in block 1130 if the decision in block 1120 is that the user has not played the game before. If the user has played the game before, then the computing device may determine whether the user scored poorly in the previous session, in decision block 1150, at which point the user can again play the tutorial in block 1130. If the user scored well in the previous session, as determined, e.g., by the computing device in decision block 1150, then the user can play the game in block 1170, followed by end block 1180.

The tutorial may be started again if requested by the user (e.g., as shown in the screen display 1200 of FIG. 10, e.g., by the question 1210 “Would you like to learn how to play?”) or if the program determines that the user's failure to meet or exceed a previous performance threshold, e.g., indicating a lack of understanding of the task.

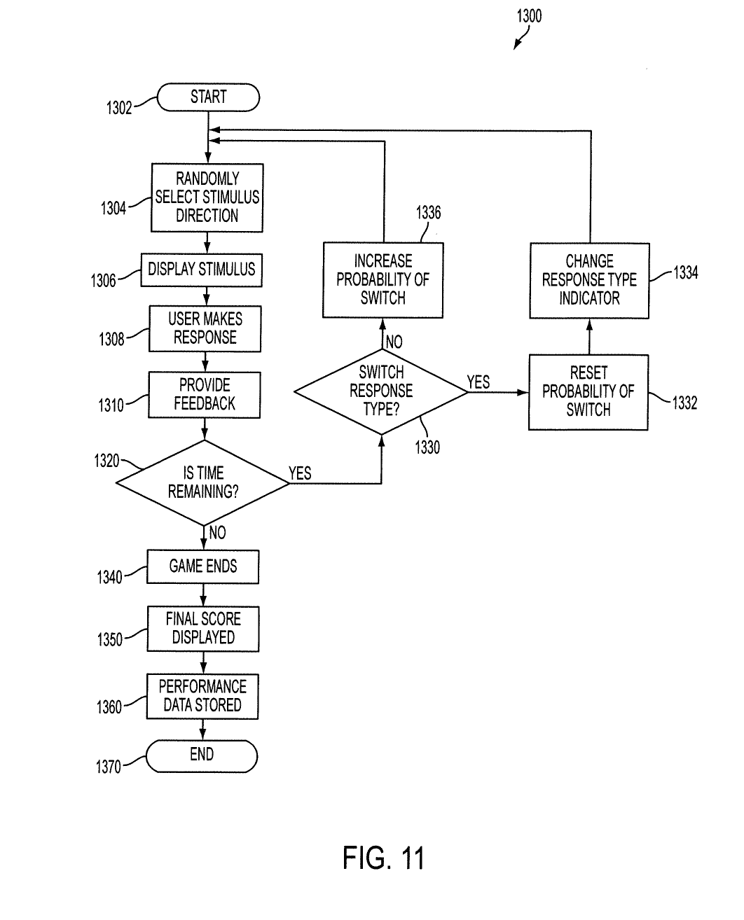

The main gameplay flow 1300 can be, for example, based on presenting trials with randomized pointing and moving directions in succession, and changing color as appropriate to the expected response from the user, as illustrated by way of example in FIG. 11). The flow diagram 1300 of FIG. 11 begins after start block 1302, by randomly selecting a stimulus direction in block 1304 and thereafter the stimulus is displayed in block 1306 and the user makes a response in block 1308. Once a response is made, feedback is provided in block 1310. If time for the game remains as determined in decision block 1320, then the computing device determines whether to switch the response type in decision block 1330. If time is not remaining, the game ends in block 1340. A final score may then be displayed in block 1350 and performance data may then be stored in block 1360 prior to the process flow ending in block 1370. If the decision in decision block 1320 is that time remains then the computing device process flow determines in decision block 1330 whether to switch the response type. If the decision is to switch the response type, then the process flow in block 1332 resets a probability of a switch and a change of response type indicator is displayed in block 1334 and the process returns to block 1304. If the decision in block 1330 is not to switch the response type then an increase in the probability of a switch is made in block 1336 and the process then returns to block 1304.

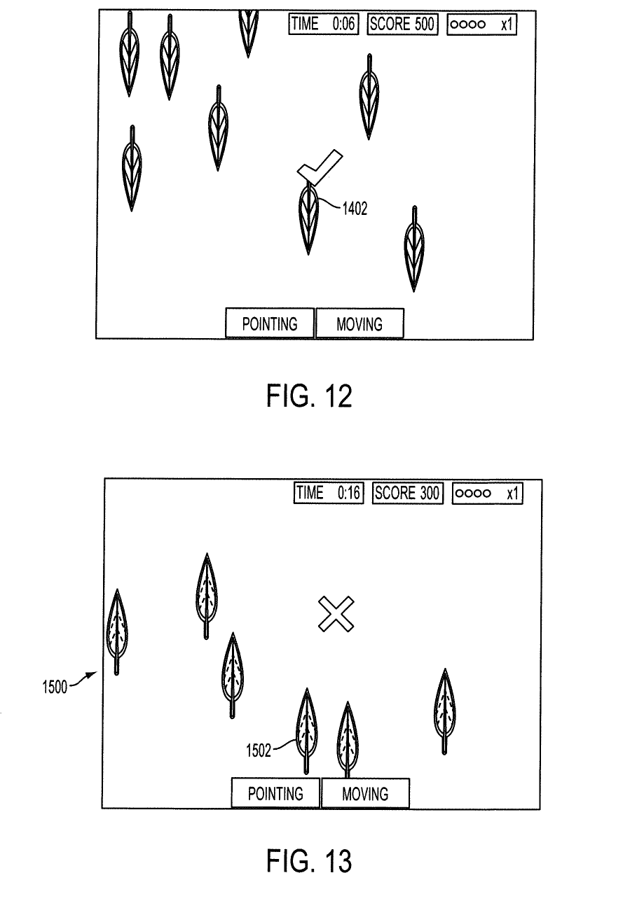

After each user response, a correct indicator 1402 may be presented on the display 1400 (e.g., the check mark as seen in FIG. 12) or an incorrect) indicator, e.g., the X mark as seen in FIG. 13 may be presented both visually (as illustrated) and auditorily. A series of trials may require repeated responses to one of the two attributes (i.e. pointing direction or moving direction) in order to build up an automatic response to that attribute which the user is training to inhibit. This effect can be adjusted by adjusting the probability of the attended attribute switching in each trial. For example, in a current implementation of the training exercise, after a trial, the probability of switching the attended attribute in the next trial can be increased until the switch occurs, after which the probability can be reset for a subsequent trial and incremented upward after succeeding trials. The probability of switching can also be adjusted depending on the speed or accuracy of the user's responses, which is not shown in the flow diagram of FIG. 11. In an implementation of the training exercise, the trials can continue for a fixed amount of time (e.g. 60 seconds), but alternatively a fixed number of trials could be used, or the number of trials could be adjusted based on the user's response time, etc. Difficulty could further be controlled by adjusting the following variables: number, size, pointiness, directionality, speed, and homogeneity of the displayed object, e.g., pointed leaves, arrows, pencils, cars, etc.

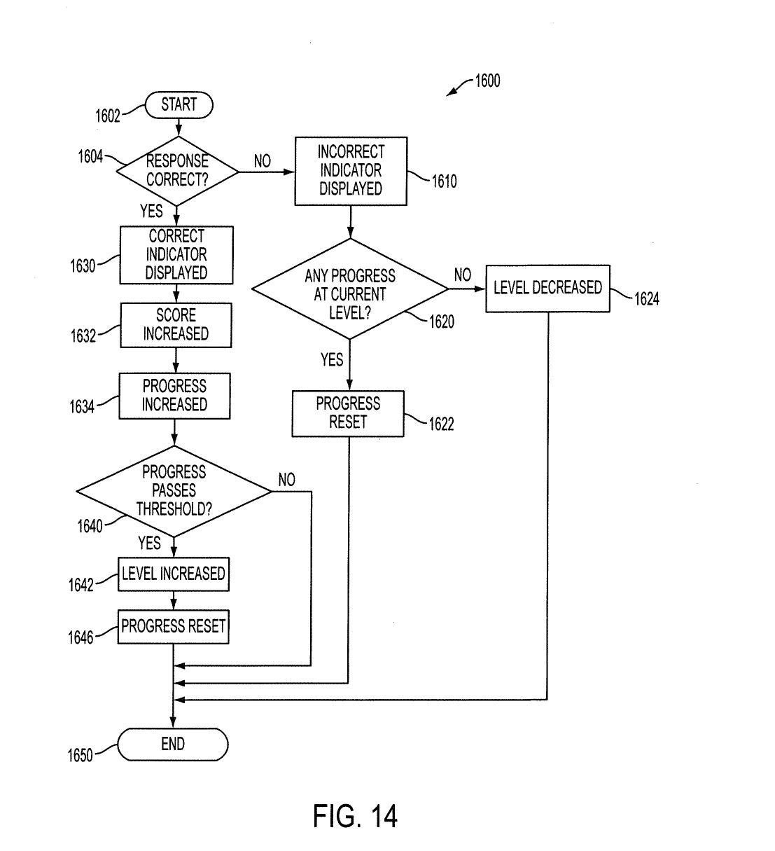

A user's performance may be determined by a combination of accuracy and speed. As an example, each correct response can be awarded points, e.g., based on a multiplier that can take into account speed of the response, e.g., as illustrated by the computing device process flow diagram 1600 of FIG. 14). The flow diagram 1600 of FIG. 14 illustrates, by way of example, how performance can be determined using accuracy and speed. After a start block 1602, the process flow determines in decision block 1604 whether the user response is correct and if not, then in block 1610 an incorrect indicator, such as is illustrated in FIG. 13 can be displayed. If the response is determined to be correct then a correct indicator, e.g., as illustrated in FIG. 12, can be displayed in block 1630. Following the incorrect indicator being displayed in block 1610, a decision can be made in block 1620 whether the user has made any progress at a current level of difficulty. If not, in block 1624, the level of difficulty can be decreased and the process flow can go to end block 1650. If progress is determined in block 1620 to have been made, then in block 1622, the level of progress can be reset and the process flow goes to decision block 1640. Following the display of the correct indicator in block 1630 the score for the user can be increased in block 1632 and progress level can be increased in block 1634. Progress can then be compared to a selected threshold in decision block 1640. If the threshold is not reached as determined in decision block 1640, then the computing device process flow goes to end block 1650. If the progress is determined to be above the threshold, then in block 1642, the level of difficulty can be increased and progress can be reset in block 1646 before the process flow goes to end block 1650.

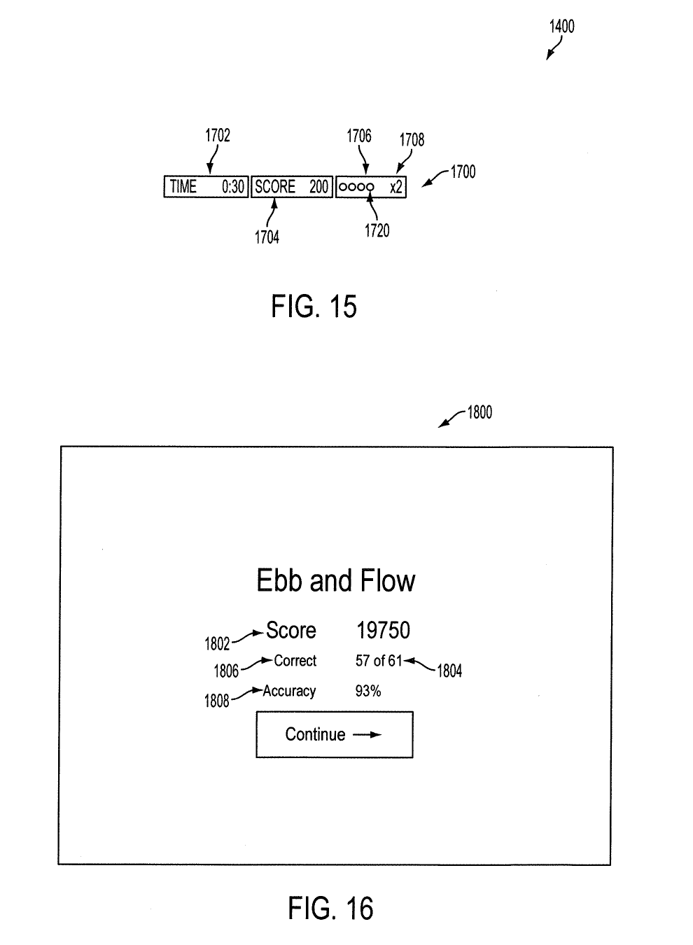

A current multiplier 1708, progress 1706, score 1704, and time remaining 1702 can be displayed to the user as a measure of progress, on an information bar 1700 as illustrated, e.g., in FIG. 15, and seen as displayed on the screens 400 and 500 of FIG. 2 and FIG. 3. A progress meter 1706 can, e.g., fill in one pip 1720 for a correct response. After four consecutive correct responses, the multiplier 1708 can be incremented and the progress meter 1706 can be reset to zero pips 1720. After an incorrect answer, the progress meter 1706 can be reset if there is progress at the current level. If there is no progress, the multiplier 1708 can be decremented. The progress mechanism can also be balanced to encourage quick responses, e.g., with about 90% accuracy, but other methods of progress measurement can occur, e.g., increasing or decreasing level based on other numbers of consecutive correct or incorrect responses, respectively, or using, e.g., a Bayesian or other adaptive statistical algorithm to, e.g., predict the optimal level for a user at any given time.

After the game is completed, the user is shown a results screen 1800, such as is illustrated by way of example in FIG. 16, on which his or her score 1802 can be displayed, e.g., alongside a final multiplier level (not shown on FIG. 16, number of trials completed 1804 and correctly completed 1806, and accuracy 1808. Other statistics may also be presented such as average response time or response differences between the different types of stimuli, etc., which are not shown in FIG. 16.

At least some aspects of the disclosed subject matter can be embodied, at least in part, in programmed software code/instructions. That is, the functions, functionalities and/or operations and techniques may be carried out in a computing device or other data processing system in response to its processor, such as a microprocessor, executing sequences of instructions contained in a memory or memories, such as ROM, volatile RAM, non-volatile memory, cache or a remote storage device. In general, the routines executed to implement the embodiments of the disclosed subject matter may be implemented as part of an operating system or a specific application, component, program, object, module or sequence of instructions usually referred to as a “computer program(s),” or “software.” The computer program(s) typically comprise instructions stored at various times in various tangible memory and storage devices, e.g., in a computing device, such as in cache memory, main memory, internal disk drives, and/or above noted forms of external memory, such as remote storage devices, such as a disc farm, remote memory or databases, e.g., accessed over a network, such as the Internet. When read and executed by a computing device, e.g., by a processor(s) in the computing device, the computer program causes the computing device to perform a method(s), e.g., process and operation steps to execute an element(s) as part of some aspect(s) of the system(s) or method(s) of the disclosed subject matter.

A tangible machine readable medium can be used to store software and data that, when executed by a computing device, causes the computing device to perform a method(s) as may be recited in one or more accompanying claims defining the disclosed subject matter. The tangible machine readable medium may include storage of the executable software program code/instructions and data in various tangible locations as noted above. Further, the program software code/instructions can be obtained from remote storage, including, e.g., through centralized servers or peer to peer networks and the like. Different portions of the software program code/instructions and data can be obtained at different times and in different communication sessions or in a same communication session, e.g., with one or many storage locations.

The software program code/instructions and data can be obtained in their entirety prior to the execution of a respective software application by the computing device. Alternatively, portions of the software program code/instructions and data can be obtained dynamically, e.g., just in time, when needed for execution. Alternatively, some combination of these ways may be used for obtaining the software program code/instructions and data may occur, as an example, for different applications, components, programs, objects, modules, routines or other sequences of instructions or organization of sequences of instructions. Thus, it is not required that the data and instructions be on a single machine readable medium in entirety at any particular instant of time or at any instant of time ever.

In general, a tangible machine readable medium can include any tangible mechanism that provides (i.e., stores) information in a form accessible by a machine (e.g., a computing device), which may be included, e.g., in a communication device, a network device, a personal digital assistant, a mobile communication device, whether or not able to download and run applications from the communication network, such as the Internet, e.g., an iPhone, iPad, Kindle, Blackberry, Droid, or the like, a manufacturing tool, or any other device including a computing device, comprising, e.g., one or more data processors, etc. In an embodiment(s), a user terminal can be a computing device, such as in the form of or included within a PDA, a cellular phone, a notebook computer, a personal desktop computer, etc. Alternatively, any traditional communication client(s) may be used in some embodiments of the disclosed subject matter. While some embodiments of the disclosed subject matter have been described in the context of fully functioning computing devices and computing systems, those skilled in the art will appreciate that various embodiments of the disclosed subject matter are capable of being distributed, e.g., as a system, method and/or software program product in a variety of forms and are capable of being applied regardless of the particular type of computing device machine or machine readable media used to actually effect the distribution.

Although some of the drawings may illustrate a number of operations in a particular order, functions, functionalities and/or operations which are not now known to be order dependent, or become understood to not be order dependent, may be reordered. Other functions, functionalities and/or operations may be combined or broken out. While some reordering or other groupings may have been specifically mentioned in the present application, others will be or may become apparent to those of ordinary skill in the art and so the disclosed subject matter does not present an exhaustive list of alternatives. It should also be recognized that the aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The disclosed subject matter is described in the present application with reference to one or more specific exemplary embodiments thereof. Such embodiments are provided by way of example only. It will be evident that various modifications may be made to the disclosed subject matter without departing from the broader spirit and scope of the disclosed subject matter as set forth in the appended claims. The specification and drawings are, accordingly, to be regarded in an illustrative sense for explanation of aspects of the disclosed subject matter rather than a restrictive or limiting sense. Numerous variations, changes, and substitutions will now occur to those skilled in the art without departing from the disclosed subject matter. It should be understood that various alternatives to the embodiments of the disclosed subject matter described as part of the disclosed subject matter may be employed in practicing the disclosed subject matter. It is intended that the following claims define the scope of the disclosed subject matter and that methods and structures within the scope of these claims and their equivalents be covered by the following claims.

What is claimed is:

1. A method of training attention ability aspects of a cognitive ability of a user comprising:
conducting, via a user computing device user interface display, a trial comprising:
presenting, via the user computing device user interface display, a plurality of objects with a recognizable pointing direction and a recognizable moving direction;
presenting, via a user computing device, the objects in one of a corresponding mode wherein the pointing direction of each object corresponds to the movement direction of each object and a non-corresponding mode wherein the pointing direction is different from the movement direction;
requiring the user to input a response indicating one of the pointing direction and the movement direction.

2. The method of claim 1 further comprising:
determining, via the user computing device, whether the response is correct or incorrect.

3. The method of claim 2 further comprising:
after a response determined to be correct, increasing, via the user computing device, a progress amount within a difficulty level for the user;
determining, via the user computing device, whether the progress amount has reached a progress amount threshold;
increasing a difficulty level if the progress amount threshold is reached or exceeded.

4. The method of claim 2 further comprising:
after a response is determined to be incorrect, determining, via the user computing device, if a decrease has occurred in a progress amount by the user at a current training difficulty level; and
if it is determined that there has not been a decrease in progress amount, decrementing, via the user computing device, the training difficulty level for the user.

5. The method of claim 1 wherein the directions comprise one of the four directions indicated by the direction input keys on a physical or virtual keyboard user interface; and
the user input is made using the physical or virtual keyboard user interface.

6. The method of claim 2 further comprising:
after determining a response to be incorrect, determining if an increase has occurred in a progress amount by the user at a current training difficulty level; and
if it is determined that there has not been an increase in progress amount, decrementing the training difficulty level for the user.

7. An apparatus for training attention ability aspects of a cognitive ability of a user comprising,
a user computing device configured to present to a user a trial comprising:
presenting on a display of the user computing device, a plurality of objects with a recognizable pointing direction and a recognizable moving direction;
presenting the objects in one of a corresponding mode wherein the pointing direction of each object corresponds to the movement direction of each object and a non-corresponding mode wherein the pointing direction is different from the movement direction; and
requiring the user to input a response indicating one of the pointing direction and the movement direction.

8. The apparatus of claim 7, the further comprising,
the user computing device configured to:
determine whether the response is correct or incorrect.

9. The apparatus of claim 8 further comprising,
the user computing device configured to:
after a response determined to be correct, increase a progress amount within a difficulty level for the user;
determine whether the progress amount has reached a progress amount threshold; and
increase a difficulty level if the progress amount threshold is reached or exceeded.

10. The apparatus of claim 8 further comprising,
the user computing device configured to:
after determining a response is incorrect, determine if a decrease has occurred in the progress amount by the user at a current training difficulty level; and
after determining there has not been a decrease in progress amount, decrement the training difficulty level for the user.

11. The apparatus of claim 7 wherein the directions comprise one of the four directions indicated by the direction input keys on a physical or virtual keyboard user interface; and the user input is made using the physical or virtual keyboard user interface.

12. A tangible machine readable medium storing instructions that, when executed by a computing device, cause the computing device to execute a method of training a spatial visualization aspect of a cognitive ability of a user, the method comprising,
conducting a trial comprising:
presenting on a user computing device user interface display a plurality of objects comprising a visually recognizable pointing direction pointing in an axis with respect to the user interface display and moving in an axis with respect to the user interface display;
presenting the objects in one of a corresponding mode wherein the pointing direction of each object corresponds to the movement direction of each object and a non-corresponding mode wherein the pointing direction is different from the movement direction; and
requiring the user to input a response indicating one of the pointing direction and the movement direction.

13. The machine readable media of claim 12, the method further comprising:
determining, via the user computing device, whether the response is correct or incorrect.

14. The machine readable media of claim 13, the method further comprising:
after determining a response to be correct, increasing, via the user computing device, a progress amount within a difficulty level for the user; and
determining whether the progress amount has reached a progress amount threshold.

15. The machine readable media of claim 14, the method further comprising:
increasing a training difficulty level if the progress amount threshold is reached or exceeded.

16. The machine readable media of claim 15, the method further comprising:
after determining a response to be incorrect, determining if an increase has occurred in the progress amount by the user at a current training difficulty level; and
if it is determined that there has been an increase in the progress amount, incrementing the progress amount for the user.
